(19) United States
(12) Patent Application Publication
(10) Pub. No.: US 2005/0253386 A1
(43) Pub. Date: Nov. 17, 2005

(54) Coupling of tubular members

(76) Inventors: Alan Richard Glaze, Bromsgrove (GB); Steven Paul Webb, Tipton (GB)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/518,574

(22) PCT Filed: Jun. 19, 2003
(86) PCT No.: PCT/GB03/02629

§ 371 Date: Dec. 22, 2004

(30) Foreign Application Priority Data
Jun. 22, 2002 (GB) 0214449.1
Jul. 25, 2002 (GB) 0217263.3

(51) Int. Cl. F16L 17/00

(52) U.S. Cl. 285/353

(57) ABSTRACT

A device (20) or restricting removal from the end of a tubular member (2) of a collar (4) or the like located on the tubular member (2) and a method using the device (20), the device (20) comprising an axially extending portion (22) for engagement in the end of the tubular member (2) and a radially outwardly extending portion (28) which in use is located outside the end of the tubular member (2) and which extends radially outwardly to a greater diameter than the internal diameter of the collar (4), thereby to restrict removal of the collar (4) from the end of the tubular member (2). In addition there is provided (20) for sealing the axially facing end of a tubular member (2), the device (20) comprising an axially extending portion (22) for engagement in the tubular member (2), a radially outwardly extending portion (28) which in use is located outside the tubular member (2) and a sealing means (48) for sealing between the radially outwardly extending portion (28) and the axially facing end (54) of the tubular member (2).

The present invention relates to a device for restricting removal from the end of a tubular member of a collar or the like located on the tubular member. The invention also relates to a method of restricting removal of a collar or the like from a tubular member.

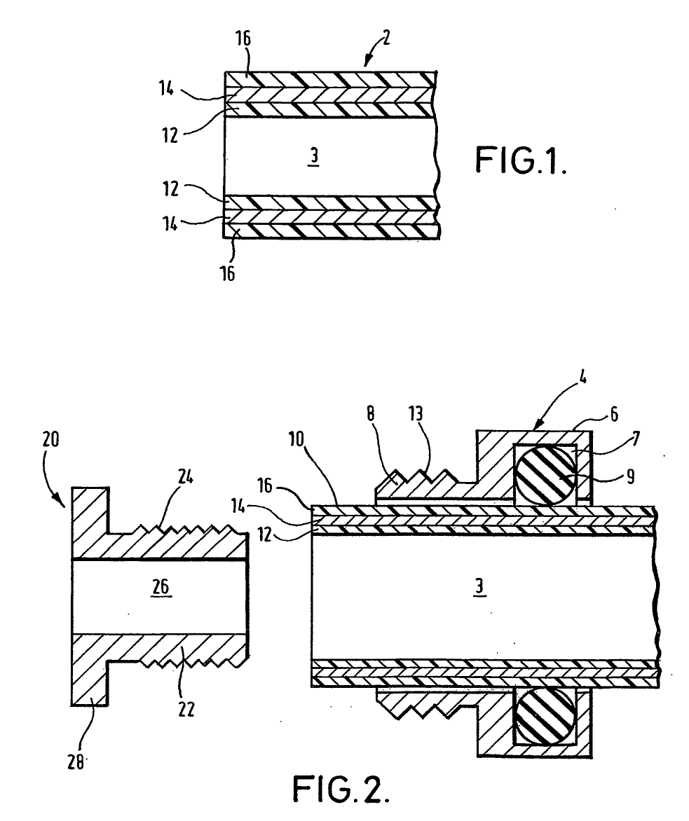

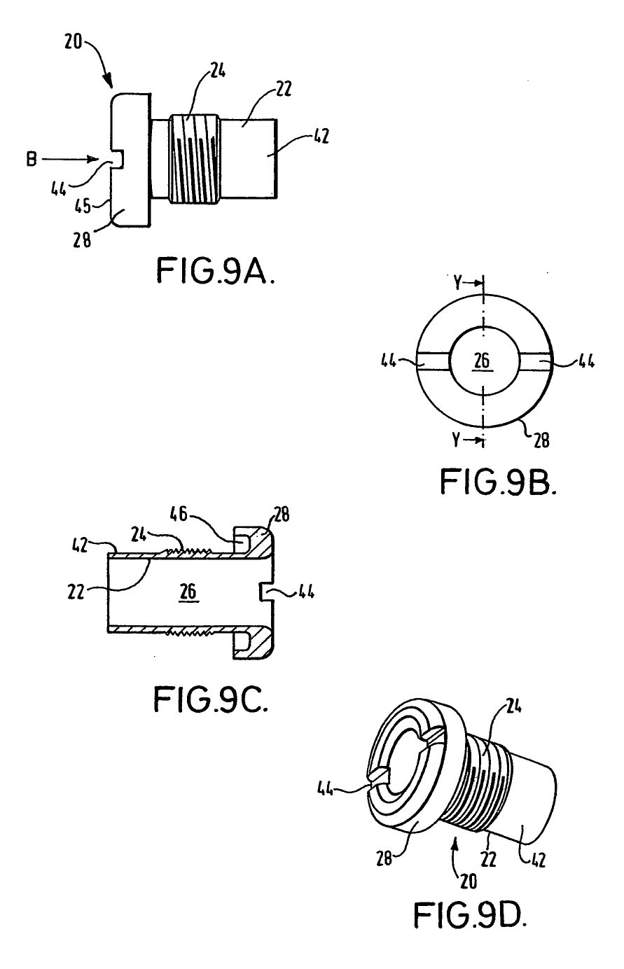

There exist applications in which a collar or other like component is located on a tubular member and must be retained thereon. An example of such an application is described in a previous patent application of the applicant, PCT/GB98/03437. That application describes a threaded annular collar for location about a pipe, the threaded collar being for engagement with a threaded tubular inlet of another structure thereby to connect the pipe thereto. The collar is retained on the end of the pipe by outwardly distorting the end of the pipe around at least a portion of the periphery of the pipe. The distortion of the pipe may be readily performed using a crimping tool as shown in FIGS. 9 to 13 of PCT/GB98/03437. This method of distorting the pipe end works well when the pipe is metal. However, in many applications the pipe comprises plastics or is a so called multi-layer pipe having bonded layers of plastics and non-plastics, eg metal, materials. An example of a multilayer pipe is shown, for example, in FIG. 1, in which the multi-layer pipe comprises two plastics layers each bonded to an intermediate metal layer. Such plastics or plastics containing pipes cannot easily be permanently distorted outwardly like metal pipes due to the resilient nature of plastics materials which means they readily reform after distortion. Moreover, if the plastics pipe is deformed too much the pipe is likely to fracture. Accordingly, the prior art method of distorting the end of the pipe is not applicable to plastics or plastics containing multi-layer pipes.

Therefore, there exists a need for an alternative means of restricting or preventing separation of a collar or the like from the end of a pipe which is suitable for plastics or plastics containing multi-layered pipes.

Further problems arise with multi-layer pipes (MLP). Problems can result from exposed ends of the MLP, e.g. the axially facing ends where it has been cut. At such exposed ends, the metal intermediate layer(s) for example can come into contact with any fluid with which the MLP may be used. Such fluid may give rise to corrosion or problems of delamination of the MLP. It is also an aim of the invention to reduce or overcome these problems.

According to the first aspect of the present invention there is provided a device for restricting removal from the end of a tubular member of a collar or the like located on the tubular member, the device comprising an axially extending portion for engagement in the end of the tubular member and a radially outwardly extending portion which in use is located outside the end of the tubular member and which extends radially outwardly to a greater diameter than the internal diameter of the collar, thereby to restrict removal of the collar from the end of the tubular member.

According to a second aspect of the present invention there is provided a method of restricting removal from the end of a tubular member of a collar or the like located on the tubular member, the method comprising the steps of providing a device according to the first aspect of the invention and engaging the axially extending portion of the device in the end of the tubular member thereby to restrict removal of the collar from the end of the tubular member.

The term tubular member used herein includes, without limitation, any tube, pipe, conduit, duct or the like. Moreover, the tubular member, whilst typically circular cylindrical, is not limited to any particular section type or shape.

The tubular member may include plastics material, be made purely of a plastics material or may be a so-called multi-layer construction comprising one or more layers of plastics material and one or more layers of non-plastics material, e.g. metal or, comprises one or more layers of plastics material bonded to one or more layers of non-metallic material. The plastics may include PE, PEx and/or PB. Preferably, the multi-layer construction has the one or more layers of plastics material alternately bonded to the one or more layers of non-plastics material, e.g. metal, such as a sequence plastics, metal, plastics, etc. More preferably, the tubular member has a multi-layer construction comprising an inner plastics material layer bonded to an intermediate layer of metal which is in turn bonded to an outer layer of plastics material. A multi-layer pipe having a plastic-metal-plastic structure for example is shown schematically in FIG. 1. The metal may comprise aluminium or steel for example.

The term “collar” used herein includes, without limitation, any annular member locatable on the tubular member. In particular, it includes, without limitation, any nut, cap, sleeve or ring. The collar may be circumferentially continuous or discontinuous.

The device is typically a hollow member thereby to allow fluid flow therethrough. For example, the device may be tubular.

The device preferably takes the form of an insert for the tubular member which is self retaining in the end of the tubular member in use. The device is preferably retained in the tubular member end with sufficient strength to withstand the axial forces which it is subjected to in use, eg due to fluid pressures. The device may, however, be removable so it can be detached when required, eg when it is desired to remove the collar from the tubular member.

The device, or at least the axially extending portion thereof, preferably comprises harder material than the inner wall of the tubular member, eg to enable the device to cut into the inner wall of the tubular member to retain itself.

The device may be retained in the end of the tubular member by threaded engagement.

The device may be retained in the end of the tubular member by cutting its own thread into the tubular member. The device may be retained in the end of the tubular member by forming a thread into the wall of the tubular member. The device may be provided on the external surface of its axially extending portion with a thread, eg a self tapping thread, for cutting or forming into the internal surface of the tubular member. In this embodiment, the device, or at least the threaded portion thereof, is preferably made of metal or other hard material to cut into the plastics wall of the tubular member where the tubular member comprises plastics.

The device is preferably provided with means to allow the device to be gripped or engaged in order to turn the device for example when screwing the device into the end of the tubular member. Preferably, the means allow the device to be gripped or engaged by a tool. The grip means may comprise a polygonal, eg hexagonal, profile on the radially outwardly extending portion to enable it to be gripped by a tool eg spanner. Alternatively, the grip means may comprise a polygonal shaped recess or internal bore in the end of the device with the radially outwardly extending portion which could be engaged by a polygonal key eg an Allen (trade name) key. Alternatively the end of the device, ie to the rear of the radially outwardly extending portion, may be provided with one or more slots which can be engaged by a tool or key for turning the device.

The device may be retained in the end of the tubular member by means of an interference fit. For example, the device may be provided on the external surface of its axially extending portion with, e.g., a serrated or saw tooth profile which permits relatively easy insertion in the tubular member end but resists withdrawal to retain the device in place. Again, in this embodiment, preferably the device, or at least the serrated etc portion thereof, is made of metal or other hard material so that the serrated edge cuts or digs into the relatively softer plastics material of the wall of the tubular member where the tubular member comprises plastics.

Further alternatively, the device may be provided on its axially extending portion with one or more outwardly angled teeth or barbs for engagement with the inner wall of the tubular member thereby to restrict withdrawal of the device. The teeth or barbs may be pressed from the body of the device which preferably comprises a metal, e.g. stainless steel, for this purpose.

The teeth or barbs referred to in the preceding paragraph may be present in the device as it is pushed into the end of the tubular member thus, acting in the form of outwardly resiliently biased barbs, for example, which bite into the inner tube wall if it is attempted to withdraw the device from the tubular member. However, such barbs or teeth may be formed in situ by inserting, for example, a device having a plain, axially extending portion of a size co-operating with the bore of the tubular member. The wall of the axially extending portion may then be deformed by tool means, for example, such as to form barbs or teeth in situ which are pushed outwardly so as to bite into or otherwise engage the bore of the tubular member. The tool means may comprise a plier-like tool having suitable jaw formations so that when squeezed onto the insert and tubular member end a projection is formed from the insert wall to engage the tube bore. The tool means may be used to provide engaging teeth or barbs in several positions around the insert/tube end periphery.

Such teeth or barbs as are pushed into the wall of the tubular member may be pre-formed in the sense that at least a part of a separation line between insert wall and barb is formed before the insert is pushed into the end of the tubular member, the barb then being deformed into the wall of the softer material of the tubular member.

Until this deformation step is performed, the insert may still be easily withdrawn from the end of the tubular member.

In this method of the present invention wherein the material of the insert is deformed into the material of the tubular member with tool means. It is within the scope of the present invention that the material of the insert device is merely stretched and deformed into the material of the tubular member without actually being penetrated or split itself, i.e. the gripping or engaging portions deformed into the wall of the tubular member are in the form of upstanding pips and the wall of the insert is not pierced.

A further alternative method for retaining the device in the end of the tubular member is for the device to be adapted to be a simple fit in the tubular member end and an adhesive to be applied between the device and the tubular member to secure the device in place. In this embodiment, the device may comprise plastics, metal or other material. Where the tubular member comprises plastics, at least the part of the device to be bonded thereto is preferably plastics to match the tubular member thus enabling a stronger bond. Preferably, the material of the insert is the same as the material of the tubular member. Where the device comprises plastics, a tough plastics material is preferred, eg ABS.

The radially extending portion of the device may be a circumferentially continuous portion, eg a circular flange. However, the radially extending portion may be of any shape. The radially extending portion may be non-circumferentially continuous, eg comprising one or more distinct radially extending segments or arms.

The device may comprise a portion of outwardly tapering diameter from the axially extending portion towards the radially extending portion. Thus, as the outwardly tapering portion is engaged in the end of the tubular member, the end of the tubular member is distorted outwards thereby to further restrict removal of the collar from the tubular member. In addition, the device may comprise a portion of enlarged diameter compared with the axially extending portion between the outwardly tapering diameter portion and the radially extending portion.

As mentioned above, further problems arise with multi-layer pipes (MLP) from the exposed ends of the MLP. For example, when a MLP is cut, the plastics and metal layers at the end become exposed. If the end is then exposed to a fluid, for example after being inserted through a compression gland or fitting, the metal layer(s) for example can be subjected to corrosion or there may be problems of delamination of the MLP. It is also an aim of the invention to reduce or overcome these problems.

According to a third aspect of the invention, there is provided a device for sealing the axially facing end of a tubular member, the device comprising an axially extending portion for engagement in the tubular member, a radially outwardly extending portion which in use is located outside the tubular member and a sealing means for sealing between the radially outwardly extending portion and the axially facing end of the tubular member.

Thus, with the sealing means sealing between the device and the axial end of the tubular member, in the case of a multi-layer pipe, the sealing means prevents fluid from directly contacting the metal layer in the pipe which could otherwise cause corrosion of the metal layer or cause de-lamination of the pipe.

Preferably, the sealing means is a resilient sealing means. Preferably, the sealing means is annular, i.e. circumferentially continuous, to seal against the annular axial end of the tubular member. The term annular used herein includes a circular shape but also includes shapes other than circular, e.g. square. The sealing means may take the form of a resilient washer or the like. Preferably, the radially outwardly extending portion is provided with a groove or recess on its front surface, i.e. the surface facing the axially facing end of the tubular member, which accommodates the sealing means. More preferably, the radially outwardly extending portion is provided with an annular groove or recess on its front surface, i.e. the surface facing the axially facing end of the tubular member, which accommodates an annular sealing means.

The sealing means may comprise for example an elastomer material. The sealing means may comprise an injected material such as a silicone sealant, for example.

The radially extending portion may be radially extending to a diameter greater than the tubular member, for example in accordance with the first and second aspects of the invention, or it may be of less diameter than the outer diameter of the tubular member. Preferably, the radially extending portion is radially extending to a diameter substantially the same diameter as the outer diameter of the tubular member.

Thus, in the embodiments where the radially extending portion is radially extending to a diameter substantially the same as or less than the outer diameter of the tubular member, there are no problems inserting the tubular member with device through any aperture or the like through which the tubular member is intended to be inserted.

The device according to the third aspect of the invention may be used where the tubular member is provided with fittings such as compression or push-fit fittings or the like.

The features of the first and second aspects of the invention may be used with the third aspect of the invention and vice versa, except where features are clearly incompatible.

Preferred embodiments of the invention will now be described, by way of example only, and with reference to the accompanying drawings in which:

FIG. 1 shows a cross sectional side view of construction of multi-layer pipe with which the invention may be used;

FIG. 2 shows in cross sectional side view a device according to the invention for use with the pipe and collar shown;

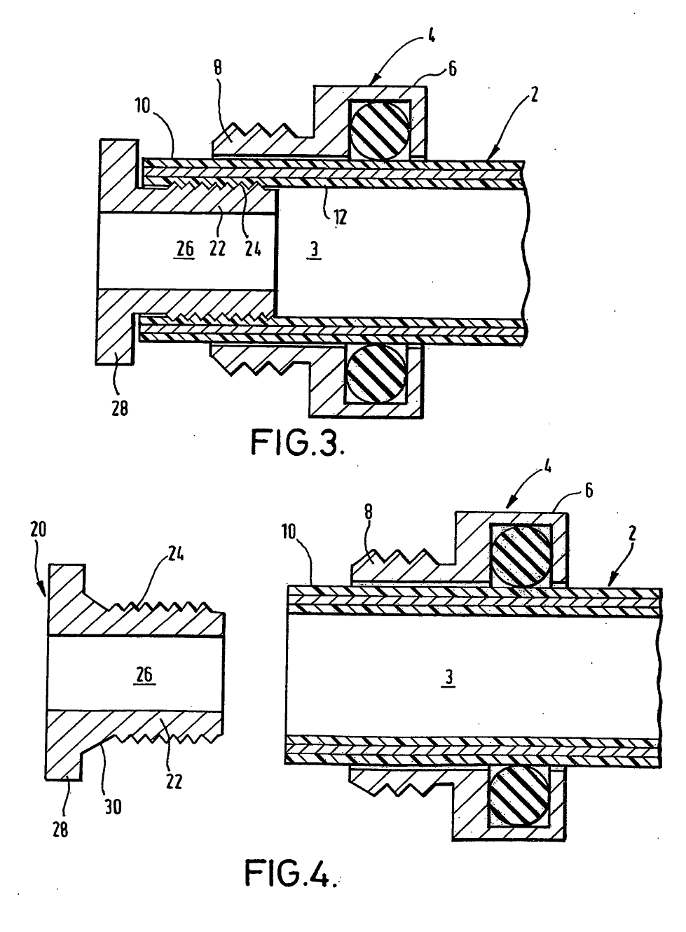

FIG. 3 shows the device of FIG. 2 in use in the end of the pipe;

FIG. 4 shows, in cross sectional side view, another embodiment of device according to the invention;

FIG. 5 shows the device of FIG. 4 in use inserted in the end of the pipe;

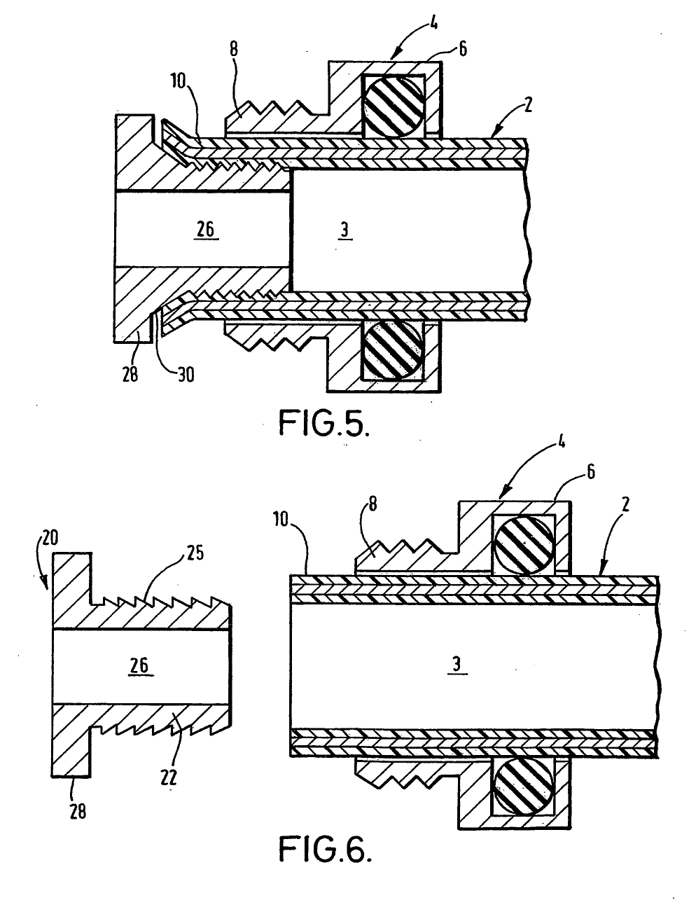

FIG. 6 shows, in cross sectional side view, a further embodiment of device according to the invention;

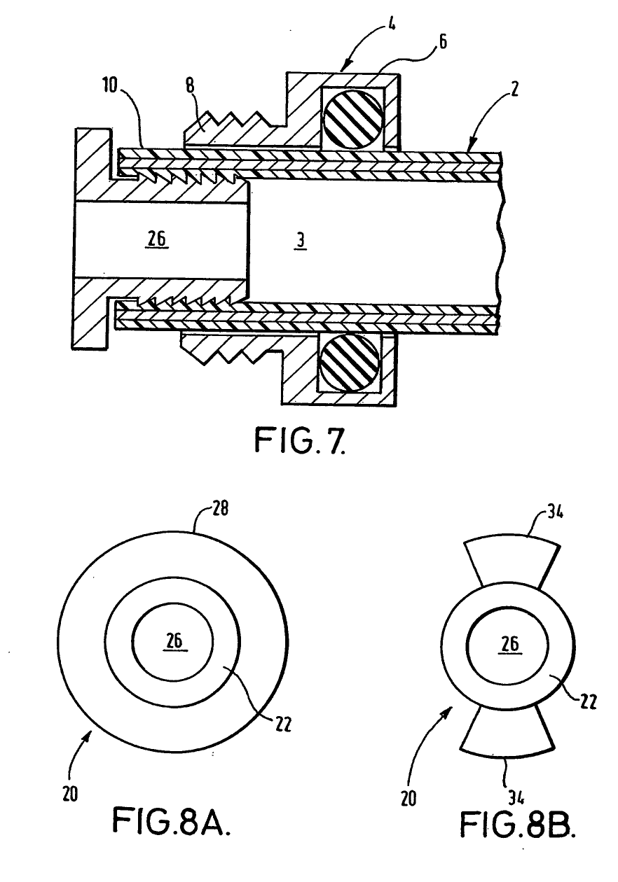

FIG. 7 shows the device of FIG. 6 in use inserted in the end of the pipe;

FIG. 8A shows an end view of a device according to the invention;

FIG. 8B shows an end view of a further embodiment of a device according to the invention having an alternative flange shape;

FIG. 9A shows a side view of a still further embodiment of device according to the invention;

FIG. 9B shows an end view of the device in FIG. 9A looking in the direction of arrow B;

FIG. 9C shows a cross sectional side view on the line Y-Y of the device in FIGS. 9A, 9B; .

FIG. 9D shows a perspective view of the device in FIGS. 9A-C;

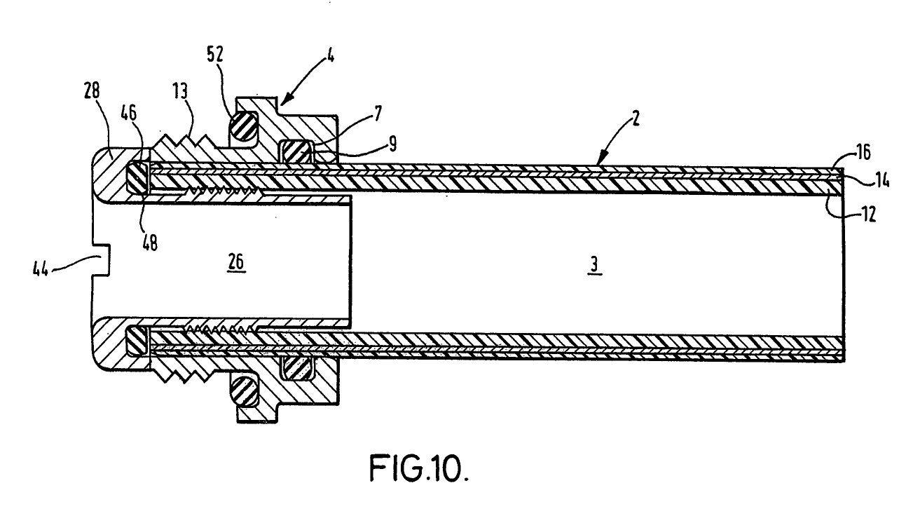

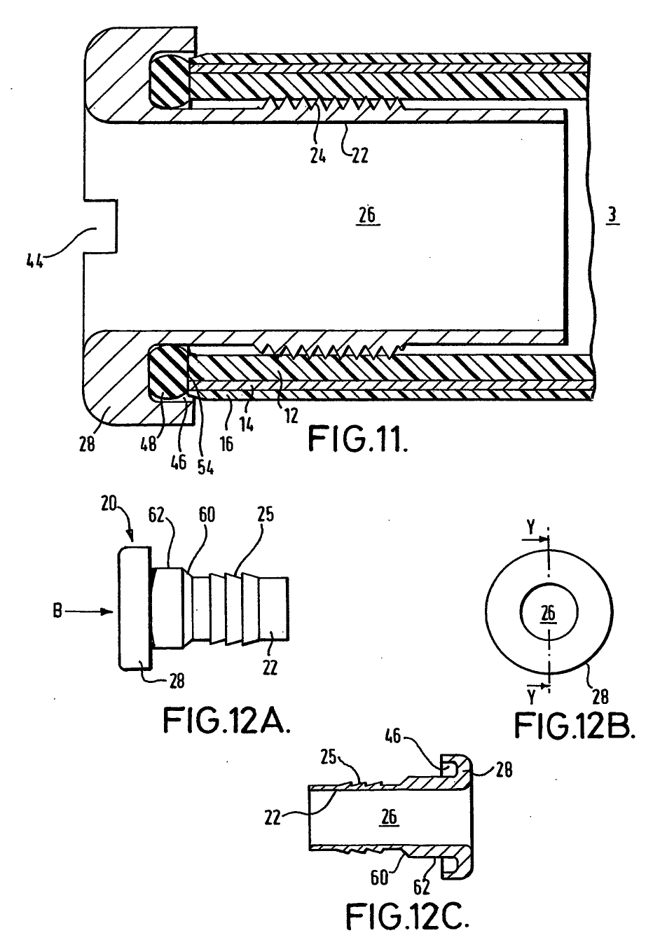

FIG. 10 shows the device of FIGS. 9A-D in use inserted in the end of a pipe having a collar mounted thereon;

FIG. 11 shows an enlarged view of the device in use as shown in FIG. 10;

FIG. 12A shows a side view of a yet further embodiment of device according to the invention;

FIG. 12B shows an end view of the device in FIG. 12A looking in the direction of arrow B;

FIG. 12C shows a cross sectional side view on the line Y-Y of the device in FIGS. 12A, 12B;

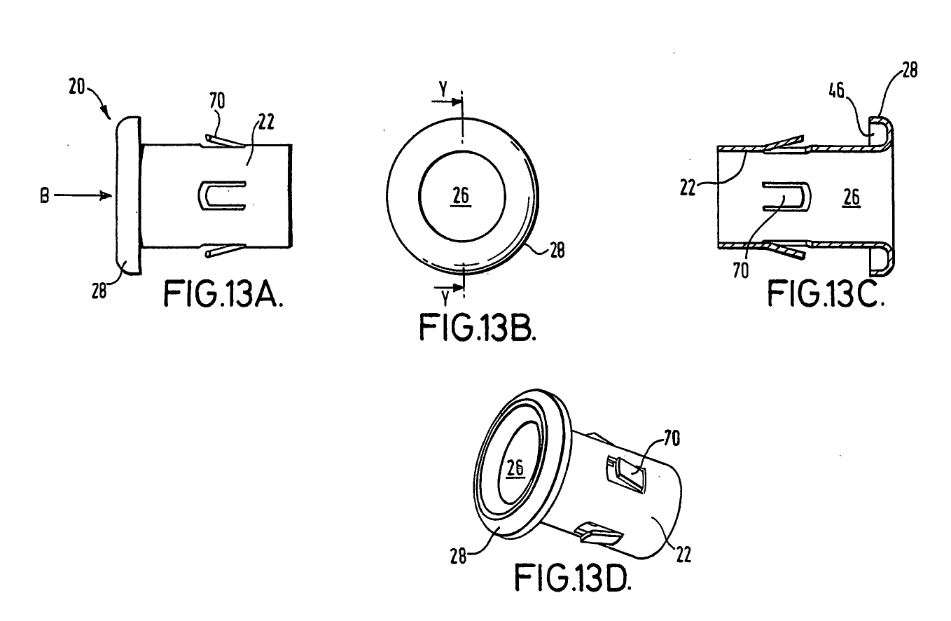

FIG. 13A shows a side view of a still another embodiment of device according to the invention;

FIG. 13B shows an end view of the device in FIG. 13A looking in the direction of arrow B.;

FIG. 13C shows a cross sectional side view on the line Y-Y of the device in FIGS. 13A, 13B;

FIG. 13D shows a perspective view of the device in FIGS. 13A-C;

FIG. 14 shows a side view of a still further embodiment of device according to the invention;

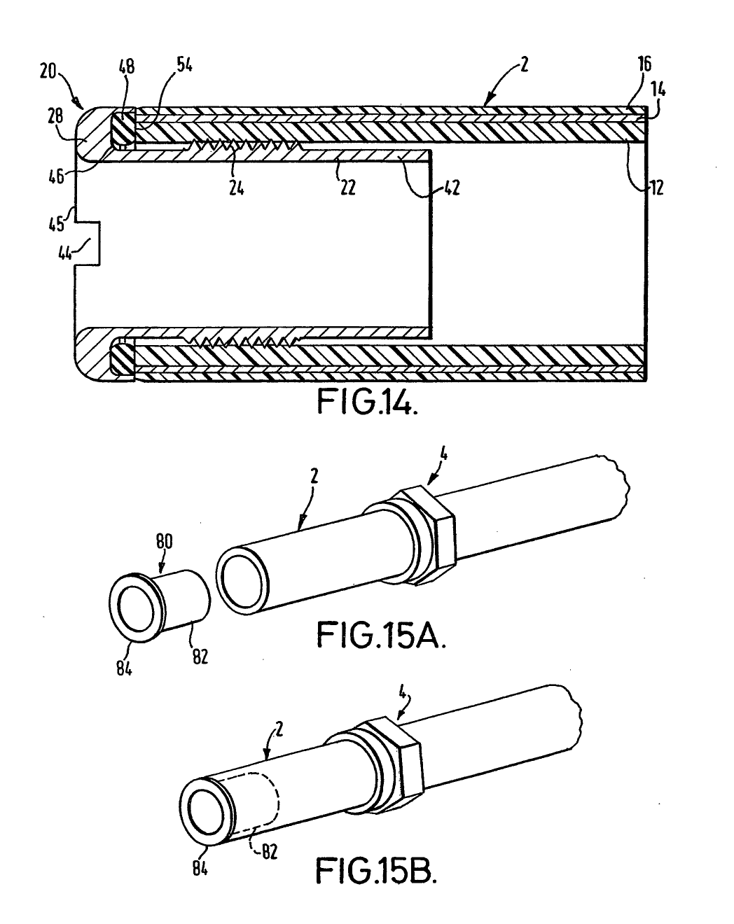

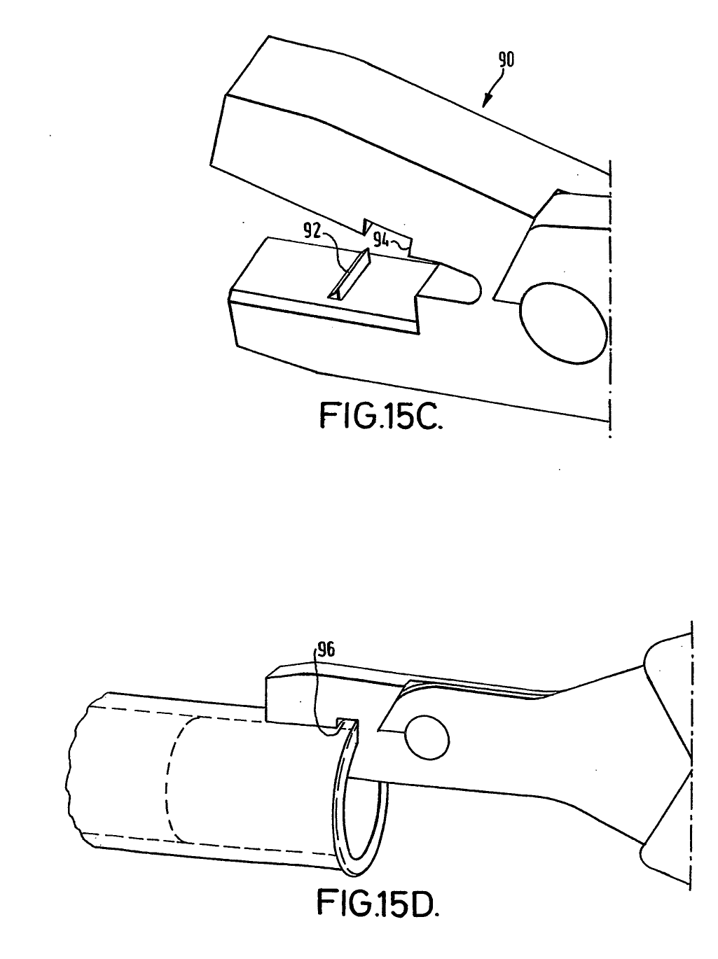

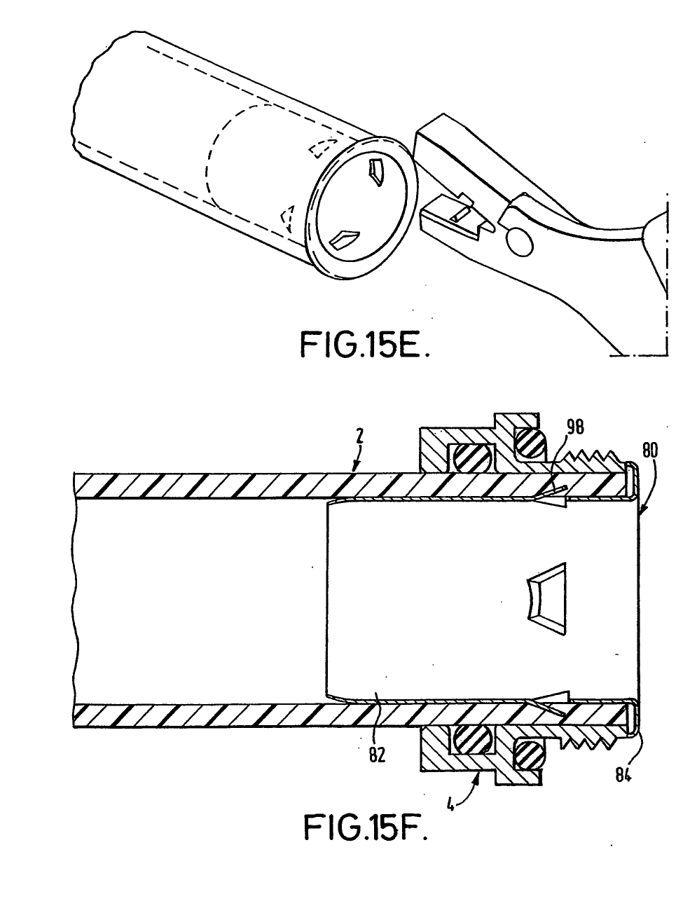

FIGS. 15A to 15F show a sequence of steps in a method according to the present invention of securing an insert device into the end of a tubular member; and

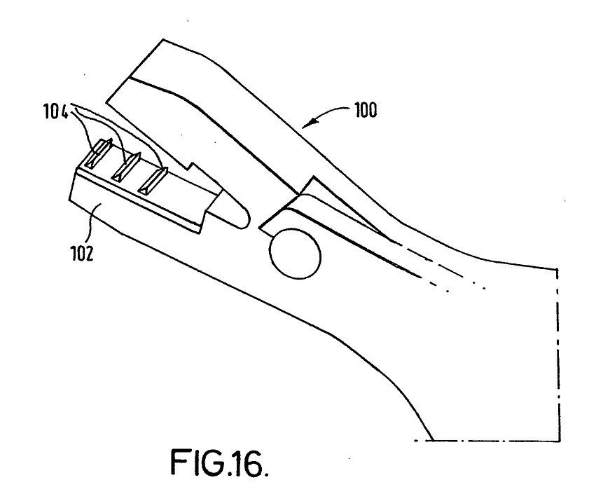

FIG. 16 which shows an alternative jaw formation to a pair of deforming pliers which may be used in the method depicted in FIG. 15.

Like reference numerals will be used to denote like parts wherever applicable.

Referring to FIG. 1, there is shown a cross sectional side view of a multi-layer pipe with which a device according to the invention may be used. The pipe 2 is a circular cylindrical pipe having a bore 3 therethrough in which a fluid may flow. The wall of the pipe 2 comprises three layers an inner layer 12 comprising a plastics material, an intermediate layer 14 comprising aluminium bonded to the layer 12, and an outer layer 16 comprising plastics material bonded to the intermediate layer 14. Such multi-layer pipes are now common in domestic situations and have many uses.

Referring to FIG. 2, there is shown a multi-layer pipe 2 as shown in FIG. 1, having mounted thereabout an annular collar 4. However, it will be appreciated that the invention is not limited to use with multi-layer pipes, but may, for example, be used with a purely plastics pipe. The collar 4 comprises an enlarged diameter section 6 having in its internal diameter surface a circumferential groove 7 for retaining an ‘O’ ring 9 which seals against the surface of the pipe 2. The collar further has a smaller diameter section 8 extending in the axial direction from section 6 which carries a thread 13 for engagement with a threaded inlet of another structure (not shown). In the prior art, the end 10 of the pipe 2 would be distorted outwardly (not shown) in order to retain the collar 4 on the pipe. Thereby, with the collar 4 captive on the pipe, engagement of the collar 4 with the threaded inlet of the other structure enables the pipe to be connected to the other structure.

The prior art method of outwardly distorting the end 10 of the pipe 2 does not work with plastics pipes or multi-layer pipes such as shown in FIG. 1 for example. The plastics material reforms such that permanent distortion of the pipe is not achievable. A device according to the invention is shown in the left hand part of FIG. 2. The device is in the form of a tubular insert 20 and made of metal. The insert 20 has a circular cylindrical bore 26 for fluid communication with the bore 3 of the pipe 2. At one end, the insert 20 has a generally circular cylindrical axially or longitudinally extending section 22 which carries a self tapping thread 24 on its external surface. At its other end, the device 20 has a radially outwardly extending circular flange 28. The flange 28 has a diameter which is greater than the outer diameter of the pipe 2 and also greater than the inner diameter of the collar 4.

The manner of use of the insert 20 to prevent removal of the collar 4 from the pipe 2 is shown in FIG. 3. The axially extending section 22 is screwed into the end of the pipe 2 such that the self tapping thread 24 cuts its own thread in the plastics inner layer 12 of the wall of the pipe 2. Thus, insert 20 is self retained in the pipe 2 and can withstand the axial and radial forces to which it is subjected in use, eg due to fluid pressure. It can be seen from FIG. 3 that the radially extending flange 28, being of larger diameter than the internal diameter of the collar 4, prevents removal of the collar 4 from the end of the pipe 2. The insert 20 can be unscrewed from the pipe 20, if desired, to allow removal of collar 4 from the pipe.

Referring to FIG. 4 there is shown a further embodiment of device according to the invention. In this embodiment, there is an outwardly tapering section 30 between the section 22 and the flange 28. In other respects, the device is the same as in FIGS. 2 and 3. When the insert 20 is screwed into the pipe as shown in FIG. 5, the end 10 of the pipe 2 meets the outwardly tapering section 30 of the insert 20 and thereby the end 10 of the pipe becomes outwardly deformed. The outwardly deformed end of pipe 2 further acts to prevent removal of the collar 4.

Referring to FIG. 6, there is shown a still further embodiment of device according to the invention. This embodiment is substantially similar to that shown in FIGS. 2 and 3 except that the axially extending section 22 has its outer surface serrated with saw teeth 25. The insert 20 shown in FIG. 6 can be push fitted into the pipe 2 as shown in FIG. 7, after which the insert 20 is retained in position as the saw teeth 25 bite into the plastics inner surface 12 of the pipe 2 to resist movement in the reverse direction.

Referring to FIG. 8A, there is shown schematically an end view of a device 20 as shown in FIGS. 2-7. The flange 28 is a circumferentially continuous circular flange. An alternative shape of radially outwardly extending portion is shown in FIG. 8B. In that embodiment, in place of a circular flange 28, the radially outwardly extending portion is circumferentially discontinuous in the form of two radially outwardly extending segments 34. It will be appreciated that other shapes of radially outwardly extending portion may be used.

Referring to FIGS. 9A-D there is shown a further embodiment of device according to the invention. In this embodiment, an insert 20 again comprises a generally tubular form having an axially extending portion 22 which carries a self tapping thread 24 thereon. In this embodiment, there is also a plain, ie non-threaded, axially extending portion 42 beyond the portion 22. The radially outwardly extending portion 28 is again in the form of a circular flange 28 which in this case is provided with two slots 44 in its rear surface 45 which can be engaged by a turning tool to permit the insert 20 to be turned and screwed into the end of the pipe 2 (see FIG. 10). As shown in FIG. 9C, the radially outwardly extending portion 28 is provided with an annular recess 46 in its forward radial surface facing ie the surface facing towards the thread 24.

As shown in FIG. 10, the insert 20 is screwed in the end of the multi-layer pipe such that the self tapping thread 24 cuts a thread into the plastics inner wall 12 of the pipe 2. As shown in FIG. 10, and more clearly in the enlarged view in FIG. 11, the annular recess 46 in the radially outwardly extending portion 28 of the insert 20 is provided with an annular sealing means 48 in the form of a soft elastomer material. This sealing means 48 provides an effective fluid tight seal between the radially outwardly extending portion 28 and the axial end surface 54 of the pipe 2. In particular, the sealing means 48 ensures that the metal layer 14 of the multi-layer pipe 2 is not contactable by any fluid, thus avoiding problems of metal corrosion or delamination of the metal layer from the adjacent plastics layers of the pipe.

Referring to FIGS. 12A-C, there is shown another embodiment of device according to the invention. An insert 20 has a generally tubular form having an axially extending portion 22 having thereon a serrated portion 25 similar to that as shown in FIGS. 6 and 7. At the end of the insert 20, there is a radially outwardly extending circular flange portion 28 which has an annular recess 46 in its forward facing surface similar to that shown in FIGS. 9-11. In between the axially extending portion 22 and the radially outwardly extending portion 28 there is a portion 62 of enlarged diameter compared with the axially extending portion 22. The portion 62 is of slightly larger diameter than the diameter of the serration's 25. The portion 62 is, however, still of significantly less diameter than the flange 28. In the transition between the axially extending portion 22 and the enlarged diameter portion 62, there is an outwardly tapering section 60. The purpose of the outwardly tapering section 60 and the enlarged diameter portion 62 is similar to that of the outwardly tapered section 30 in the embodiment shown in FIGS. 4 and 5. As the insert 20 is pushed into the end of the pipe 2, the outwardly tapering section 60 begins to force the end of the pipe to deform outwardly and when the insert 20 is fully inside the pipe 2 with the enlarged diameter portion 62 inside the end of the pipe 2, the end of the pipe 2 is maintained in an outwardly deformed state thereby to further restrict removal of the collar from the end of the end of the pipe.

Referring to FIGS. 13A-D, there is shown a still further embodiment of device according to the invention. Again, an insert 20 of stainless steel, for example, comprises a generally tubular form having an axially extending portion 22 of substantially circular cylindrical form and at the end thereof a radially outwardly extending circular flange 28. The tubular insert 20 has a circular cylindrical bore 26 therethrough. In this embodiment, the insert 20 is retained in the end of the pipe 2 after push fitting in the pipe by means of outwardly directed arms or teeth 70 which project out of the surface of the axially extending portion 22. In this embodiment, there are four such teeth 70. However, it will be appreciated that the number of teeth may be more or less than 4. Each tooth 70 is formed by providing a generally “U” shaped slot through the wall of the axially extending portion 22 and then pressing the central portion of material lying within the slot out of the plane of the surface of the axially extending portion 22 to form the outwardly projecting teeth 70. The teeth 70 are directed so that their free, outwardly extending end points towards the flange 28. In this way, the insert 20 may be pushed into the end of the pipe, but the ends of the outwardly extending teeth 70 dig into the plastics wall of the pipe in a barb-like fashion to retain the insert. The teeth 70 are resilient enough to allow the insert to be push fitted in the pipe but stiff enough to dig into the plastics wall to restrict withdrawal of the insert.

Referring to FIG. 14 there is shown a further embodiment of device according to the invention. In this embodiment, an insert 20 again comprises a generally tubular form having an axially extending portion 22 which carries a self tapping thread 24 thereon. In this embodiment, there is also a plain, i.e. non-threaded, axially extending portion 42 beyond the portion 22. The radially outwardly extending portion 28 is again in the form of a circular flange 28 which in this case is provided with slots 44 in its rear surface 45 which can be engaged by a turning tool to permit the insert 20 to be turned and screwed into the end of the multi-layer pipe 2. The radially outwardly extending portion 28 does not in this embodiment extend to a diameter greater then the outer diameter of the pipe 2. This embodiment is not for use to retain a collar on the pipe 2, but rather for the purpose of sealing the exposed end of the pipe 2.

The radially outwardly extending portion 28 is provided with an annular recess 46 in its forward facing surface i.e. the surface facing towards the thread 24. The annular recess 46 accommodates an annular sealing means 48 in the form of a soft elastomer material.

As shown, the insert 20 in use is screwed into the end of the multi-layer pipe 2 such that the self tapping thread 24 cuts a thread into the plastics inner wall 12 of the pipe 2. The insert 20 is screwed in until the sealing means 48 provides an effective fluid tight seal between the radially outwardly extending portion 28 and the axial end surface 54 of the pipe 2. The sealing means 48 ensures that the metal layer 14 of the multi-layer pipe 2 is not contactable by any fluid, thus avoiding problems of metal corrosion or delamination of the metal layer from the adjacent plastics layers of the pipe.

FIGS. 15A to 15F show a series of steps in a method of fixing an insert device 80 into the end of a tubular member 2 in the form of a plastics material or MLP-type pipe. The insert 80 is made of a metal and comprises a plain tubular, axially extending portion 82 and a flange portion 84 which extends radially sufficiently to retain a collar member 4 from being removed once the insert 80 is fixed in position. The insert 80 is pushed into the end of the tubular member (FIG. 15B). A pair of pliers 90 having a suitable jaw formation of an upstanding tooth 92 (FIG. 15C) is then brought into contact with the end of the tubular member 2 and the insert 80, a shoulder 94 on one of the plier jaws determining depth of entry into the tube/insert and a recess 98 accommodating the flange 84.

Squeezing of the plier handles together causes the tooth 92 to punch a corresponding portion 98 of the insert wall outwardly and into the bore of the tubular member so as to engage therewith (FIG. 15D) by biting into the material thereof. The tubular member may be rotated and a plurality of teeth, e.g. four, indented into the bore of the tubular member from the insert 80 (FIG. 15E). However, whilst a particular tooth formation and four indentations are depicted with reference to FIG. 15, any shape compatible with being applied by a tool may be used and any number of indentations applied. Whilst manual pliers are shown, such tools may be automated or operated by pneumatic or hydraulic means, for example. Thus, the embodiment of the method described with reference to FIG. 15 is merely to demonstrate that retaining formations of teeth or barbs may be formed in situ by any suitable means. FIG. 15F shows a cross section through the tubular member 2 and insert 80 after having the teeth formations indented therein to grip the tube bore. The collar 4 is shown retained by the flange member 84.

The portions 98 may be pre-formed in the insert 80 in the sense that they have been separated from the wall of the insert along all but one side thereof, for example, a tool, such as the pliers shown, then being used to push the separated portion into the bore of the tube wall. Thus, before insertion of the insert 80 into the end of the tubular member the portions 98 are essentially still contained within the dimensions of the cylindrical wall of the insert rather than as shown in FIG. 13, for example, where the portions 70 are bent away from the cylindrical wall before insertion.

FIG. 16 shows an alternative tool 100 wherein one jaw 102 has three upstanding teeth 104 to deform three portions of the insert wall simultaneously into the softer material of the tubular member. In this way a stronger fixing of the insert in the tubular member may be achieved.

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention.

Independent protection may be sought for these features in addition to or alternative to any invention presently claimed.

1. A device for restricting removal from the end of a tubular member of a collar or the like located on the tubular member, the device comprising an axially extending portion for engagement in the end of the tubular member and radially outwardly extending portion which in use is located outside the end of the tubular member and which extends radially outwardly to a greater diameter than the internal diameter of the collar, thereby to restrict removal of the collar from the end of the tubular member.

2. A device as claimed in claim 1 wherein the tubular member includes: plastics material; is made purely of a plastics material; or, is a multi-layer construction comprising one or more layers of plastics material bonded to one or more layers of metal; or, comprises one or more layers of plastics material bonded to one or more layers of non-metallic material.

3. A device as claimed in claim 2 wherein the tubular member has a multi-layer construction comprising an inner plastics material layer bonded to an intermediate layer of metal which is in turn bonded to an outer layer of plastics material.

4. A device as claimed in claim 1 wherein the device is a hollow member thereby to allow fluid flow therethrough.

5. A device as claimed in claim 4 wherein the device takes the form of an insert for the tubular member which is self retaining in the end of the tubular member in use.

6. A device as claimed in claim 1 wherein the device, or at least the axially extending portion thereof, comprises harder material than the inner wall of the tubular member.

7. A device as claimed in either claim 5 wherein the device is retainable in the end of the tubular member by threaded engagement.

8. A device as claimed in claim 7 wherein the device is provided on the external surface of its axially extending portion with a thread.

9. A device as claimed in claim 8 wherein the device is retainable in the end of the tubular member by cutting or forming its own thread into the tubular member.

10. A device as claimed in claim 9 wherein the thread on the device comprises a self tapping thread for cutting or forming into the internal surface of the tubular member.

11. A device as claimed in claim 1 wherein the device is provided with means to allow the device to be engaged in order to turn the device.

12. A device as claimed in claim 11 wherein the engagement means comprises a polygonal profile on the radially outwardly extending portion to enable it to be gripped by a tool.

13. A device as claimed in claim 11 wherein the engagement means comprises a polygonal shaped recess or internal bore in the end of the device with the radially outwardly extending portion for engagement by a polygonal key.

14. A device as claimed in claim 11 wherein the engagement means comprises, at the end of the device to the rear of the radially outwardly extending portion, one or more slots which can be engaged by a tool or key for turning the device.

15. A device as claimed in claim 1 wherein the device is retained in the end of the tubular member by means of an interference fit.

16. A device as claimed in claim 15 wherein the device is provided on the external surface of its axially extending portion with a serrated or saw tooth profile.

17. A device as claimed in claim 15 wherein the device is provided on its axially extending portion with one or more outwardly angled teeth or barbs for engagement with the inner wall of the tubular member.

18. A device as claimed in claim 17 wherein the teeth or barbs are pressed from the body of the device.

19. A device as claimed in claim 1 wherein the device is retained in the end of the tubular member means of an adhesive applied between the device and the tubular member to secure the device in place.

20. A device as claimed in claim 1 wherein the radially extending portion of the device is circumferentially continuous.

21. A device as claimed in claim 20 wherein the radially extending portion comprises a circular flange.

22. A device as claimed in claims 1 wherein the radially extending portion is non-circumferentially continuous.

23. A device as claimed in claim 1 wherein the device comprises a portion of outwardly tapering diameter from the axially extending portion towards the radially extending portion.

24. A device as claimed in claim 23 wherein the device further comprises a portion of enlarged diameter compared with the axially extending portion between the outwardly tapering diameter portion and the radially extending portion.

25. A device as claimed in claim 1 wherein the device includes a sealing means to seal between the device and the axial end of the tubular member.

26. A device as claimed in claim 25 wherein the sealing means is located between the radially outwardly extending portion of the device and the end of the tubular member.

27. A device as claimed in claim 26 wherein the radially outwardly extending portion is provided with an annular groove or recess on its front radially extending surface to accommodates an annular sealing means.

28. A method of restricting removal from the end of a tubular member of a collar or the like located on the tubular member, the method comprising the steps of providing a device according to any one preceding claim and engaging the axially extending portion of the device in the end of the tubular member thereby to restrict removal of the collar from the end of the tubular member.

29. A method according to claim 28 wherein means to engage a bore of the tubular member are formed by use of tool means after insertion of said device into the end of the tubular member.

30. A method according to claim 29 wherein the means to engage the bore of the tubular member are barbs or teeth pressed from the wall of the device in situ after insertion of the device into the end of the tubular member.

31.-32. (canceled)

33. A device for sealing the axially facing end of a tubular member, the device comprising an axially extending portion for engagement in the tubular member, a radially outwardly extending portion which in use is located outside the tubular member and a sealing means for sealing between the radially outwardly extending portion and the axially facing end of the tubular member.

34. A device as claimed in claim 33 wherein the sealing means is annular.

35. A device as claimed in claim 33 wherein the radially outwardly extending portion is provided in its front surface facing the end of the tubular member with a groove or recess for accommodating the sealing means.

36. A device as claimed in claim 33 wherein the groove or recess comprises an annular groove or recess for accommodating an annular sealing means.

37. A device as claimed in of claims 33 wherein the sealing means comprises an elastomer material.

38. A device as claimed in any one of claim 33 wherein the sealing means comprises and injected sealant material.

39. A device according to claim 38 wherein the sealant is a silicone material.

40. (canceled)
